(19) United States
(12) Patent Application Publication
(10) Pub. No.: US 2022/0405780 A1
(43) Pub. Date: Dec. 22, 2022

(54) ENGAGEMENT DATA OBJECTS IMPLEMENTED IN A DATA AGGREGATION MODEL TO ADAPT COMPUTERIZED ENTERPRISE DATA FLOWS

(71) Applicant: FinancialForce.com, Inc., San Francisco, CA (US)

(72) Inventors: Jocasta Katharine Rebecca Perry, Knaresborough (GB); Heidi Renee Minzner, North Andover, MA (US); Richa Dubey, Fremont, CA (US); Kevin James Jones, Harrogate (GB)

(73) Assignee: FinancialForce.com, Inc., San Francisco, CA (US)

(21) Appl. No.: 17/355,113

(22) Filed: Jun. 22, 2021

(51) Int. Cl. G06Q 30/02; G06Q 10/06

(52) U.S. Cl. CPC G06Q 30/0203; G06Q 10/067; G06Q 30/04

(57) ABSTRACT

Various embodiments relate generally to data science and data analysis, computer software and systems, and computing architectures and data models configured to facilitate management and performance of enterprise functions, and, more specifically, to an enterprise computing and data processing platform configured to identify and aggregate engagement data for managing enterprise data and work flows, and, in response to data values of aggregated engagement data, the enterprise computing and data processing platform is further configured to generate a command, for example, to modify automatically an enterprise data flow or work flow. In some examples, a method may include analyzing a pool of data including project, billing, and supply chain data to generate an engagement dataset including attributes based on aggregated subsets of project, billing, and supply chain data, and calculating updated values for the engagement dataset automatically.

### FIELD

Various embodiments relate generally to data science and data analysis, computer software and systems, and computing architectures and data models configured to facilitate management and performance of enterprise functions, and, more specifically, to an enterprise computing and data processing platform configured to identify and aggregate engagement data for managing enterprise data and work flows, and, in response to data values of aggregated engagement data, the enterprise computing and data processing platform is further configured to generate a command, for example, to modify an enterprise data flow or work flow.

### BACKGROUND

Advances in computing hardware and software have fueled exponential growth in analyzing and managing various constituent processes and functions of enterprises, as well as other organizations. For example, computing methodologies and architectures have been developed to implement customer relationship management (“CRM”) technologies. Further advancements led to development of software and computing platforms configured to implement enterprise resource planning (“ERP”) technologies to further enhance management of business processes.

An aim of conventional enterprise-related software and computing processes is to drive enterprise processes and workflows to accomplish tasks, at the expense of diminished focus on the various disparate enterprise activities and computing platforms necessary to complete such tasks. For example, an enterprise (or any organization or entity) may traditionally provide any number of services as projects (e.g., specialized resources to implement a computing solution, etc.), deliver any number of tangible items, goods, or products (e.g., computing devices, software products, etc.), manage any number of licenses or subscriptions (e.g., software licenses or subscriptions), and perform any number of other tasks that might otherwise risk operation of an enterprise or an organization as, for example, a customer. Usually, known enterprise-related software and computing processes are typically not well-suited to accurately manage the aforementioned enterprise functions to avoid risk to the enterprise and its financial health.

Adoption and implementation of software-as-a-service (“SaaS”) occurs in many industries including high-tech, software, professional services, and many other fields of endeavor. As an example, business-to-business (“B2B”) enterprises and organizations optimize types of offerings, pricing, promotions, and the like, which increases the burden of managing operations of an enterprise to provide products and/or services based on the traditionally SaaS model. Also, transparency between “front office” (e.g., sales) and “back office” (e.g., finance) functional activities is generally lacking to effectively correct enterprise processes to avoid or mitigate risk.

Further, an enterprise providing, selling, or licensing a software product conventionally provides more that the software product itself. For example, an enterprise may not only sell software as a service (“SaaS”), but may also provide professional services for implementation, training, and other managed services or ancillary products. Typically, a relationship with a customer is initiated through a selling process, and continues throughout multiples years of activity, any of which may be subject to contractual terms that drives the processes of an enterprise to fulfil its commitment to a customer.

Given the drawbacks of the various conventional enterprise-related software and computing processes, in view of the increasing complexity of managing and implementing enterprise data, enterprises are at risk of attrition, cancellations, and loss of customers.

Thus, what is needed is one or more solutions to monitor, detect, evaluate, and respond to engagement data, including aggregated engagement data, that may affect functions of an enterprise, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a diagram depicting an example of an engagement management engine configured to generate and implement a data aggregation model to manage engagement data objects and adapt computerized enterprise data flows, according to some embodiments;

FIG. 2 illustrates an exemplary implementation of an engagement data object, according to some examples;

FIG. 3 is a diagram depicting an example of architecture implementing an engagement management engine to generate and implement a data aggregation model for managing engagement data objects and adapting computerized enterprise data flows, according to some examples;

FIG. 4 illustrates an exemplary layered architecture for implementing an engagement management engine application, according to some examples;

FIG. 5 is a diagram depicting an example of an aggregated data model with which an engagement management engine may identify and analyze business functions based on levels of revenues (and/or risk thereto), according to some embodiments;

FIG. 6 is a diagram depicting a flow diagram as an example of implementing an aggregated data model including engagement data objects with which an engagement management engine may use to control enterprises processes, according to some embodiments;

FIG. 7 is a diagram depicting a flow diagram configured to aggregate revenue data, according to some embodiments;

FIG. 8 is a diagram depicting a flow diagram to implement an automated application to form an aggregated data model, according to some embodiments;

FIGS. 9 to 16 are diagrams depicting various user interfaces, according to various examples; and

FIG. 17 illustrates examples of various computing platforms configured to generate and implement a data aggregation model to manage engagement data objects and adapt computerized enterprise data flows, according to various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims, and numerous alternatives, modifications, and equivalents thereof. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description or providing unnecessary details that may be already known to those of ordinary skill in the art.

As used herein, “system” may refer to or include the description of a computer, network, or distributed computing system, topology, or architecture using various computing resources that are configured to provide computing features, functions, processes, elements, components, or parts, without any particular limitation as to the type, make, manufacturer, developer, provider, configuration, programming or formatting language, service, class, resource, specification, protocol, or other computing or network attributes. As used herein, “software” or “application” may also be used interchangeably or synonymously with, or refer to, a computer program, software, program, firmware, or any other term that may be used to describe, reference, or refer to a logical set of instructions that, when executed, performs a function or set of functions within a computing system or machine, regardless of whether physical, logical, or virtual and without restriction or limitation to any particular implementation, design, configuration, instance, or state. Further, “platform” may refer to any type of computer hardware (hereafter “hardware”) or software, or any combination thereof, that may use one or more local, remote, distributed, networked, or computing cloud (hereafter “cloud”)-based computing resources (e.g., computers, clients, servers, tablets, notebooks, smart phones, cell phones, mobile computing platforms or tablets, and the like) to provide an application, operating system, or other computing environment, such as those described herein, without restriction or limitation to any particular implementation, design, configuration, instance, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, or state) may be used for processing and/or storage of varying quantities, types, structures, and formats of data, without restriction or limitation to any particular implementation, design, or configuration.

As used herein, data may be stored in various types of data structures including, but not limited to databases, data repositories, data warehouses, data stores, or other data structures configured to store data in various computer programming languages and formats in accordance with various types of structured and unstructured database schemas such as SQL, MySQL, NoSQL, DynamoDB™, etc. Also applicable are computer programming languages and formats similar or equivalent to those developed by data facility and computing providers such as Amazon® Web Services, Inc. of Seattle, Wash., FMP, Oracle®, Salesforce.com, Inc., or others, without limitation or restriction to any particular instance or implementation. DynamoDB™, Amazon Elasticsearch Service, Amazon Kinesis Data Streams (“KDS”)™, Amazon Kinesis Data Analytics, and the like, are examples of suitable technologies provide by Amazon Web Services (“AWS”). Another example of cloud computing services include the Google® cloud platform that may implement a publisher-subscriber messaging service (e.g., Google® pub/sub architecture).

Further, references to databases, data structures, or any type of data storage facility may include any embodiment as a local, remote, distributed, networked, cloud-based, or combined implementation thereof. Also, data may be formatted and transmitted (i.e., transferred over one or more data communication protocols) between computing resources using various types of data communication and transfer protocols such as Hypertext Transfer Protocol (“HTTP”), Transmission Control Protocol (“TCP”)/Internet Protocol (“IP”), Internet Relay Chat (“IRC”), SMS, text messaging, instant messaging (“IM”), File Transfer Protocol (“FTP”), or others, without limitation. As described herein, disclosed processes implemented as software may be programmed using Java®, JavaScript®, Scala, Python™, XML, HTML, and other data formats and programs, without limitation. Disclosed processes herein may also implement software such as Streaming SQL applications, browser applications (e.g., Firefox™) and/or web applications, among others. In some example, a browser application may implement a JavaScript framework, such as Ember.js, Meteor.js, ExtJS, AngularJS, and the like. References to various layers of an application architecture (e.g., application layer or data layer) may refer to a stacked layer application architecture such as the Open Systems Interconnect (“OSI”) model or others. As described herein, a distributed data file may include executable instructions as described above (e.g., JavaScript® or the like) or any data constituting content (e.g., text data, video data, audio data, etc.), or both.

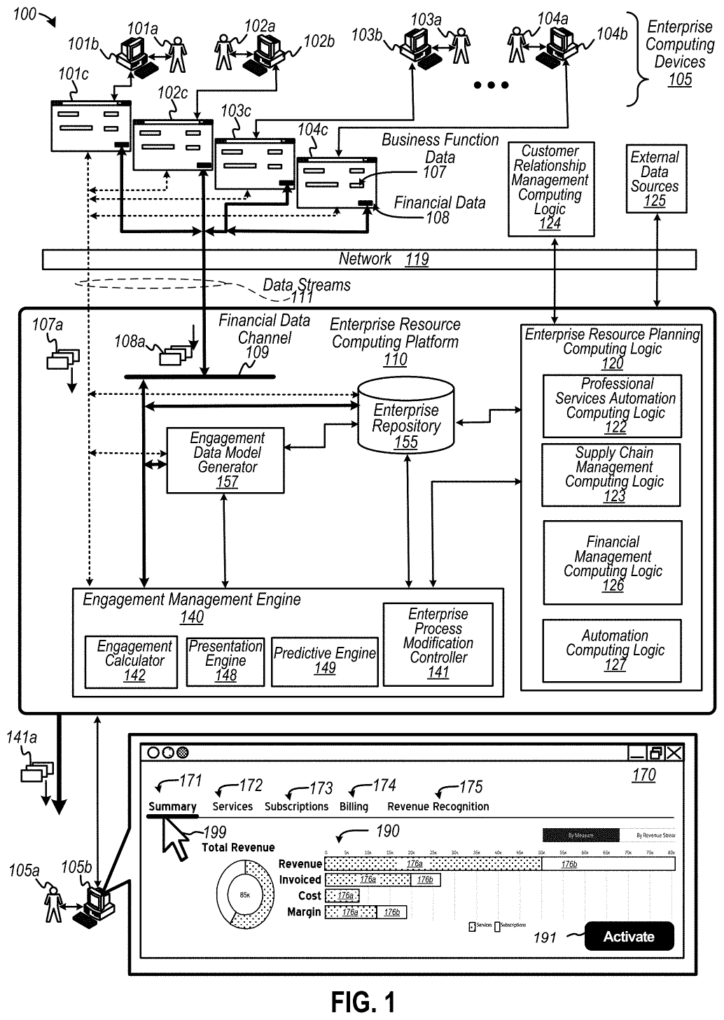

FIG. 1 is a diagram depicting an example of an engagement management engine configured to generate and implement a data aggregation model to manage engagement data objects and adapt computerized enterprise data flows, according to some embodiments. Diagram 100 depicts an example of an engagement management engine 140 configured to monitor, analyze, and respond to data values of enterprise data in data streams 111, including streams of financial data 108, to aggregate enterprise data for evaluating risk, such as financial risk, to an enterprise, organization, or any entity to avoid or mitigate possible risks to its various business processes associated with one or more software application functions and computing systems of an enterprise.

As an example, engagement management engine 140 may be configured to determine, in response to an identified financial risk, an automated course of action to modify a computer-implemented enterprise process to resolve a threat to, for example, the financial health of an enterprise. In some examples, engagement management engine 140 may be configured to classify and extract a stream of data in data streams 111 to identify a classification of a type of data that can be used to drive enterprise processes and modifications thereof. For example, classified data may be revenue data, cost data, invoice data, project data, and the like. In accordance with some examples, engagement management engine 140 is configured to interoperate with an engagement data model generator 157 to generate a data aggregation model that may include any number of engagement data objects, each of which may be populated to include data associated with project data, billing data, supply chain data, and any other enterprise-related data that may, for example, impact revenue, which is the lifeblood of many enterprises and may be the igniter to cause modification of one or more enterprise processes automatically, semi-automatically, or manually.

In accordance with some examples, engagement management engine 140 may be configured to facilitate consolidation of a type of enterprise data that may be identified and extracted from multiple disparate data sources. In at least in some cases, extracted enterprise data may include data representing revenue-related information, such as financial data 108. Also, engagement management engine 140 may be configured to generate data to cause presentation of a consolidated type of enterprise data in a user interface. In one implementation, a consolidated type of enterprise data may include multiple revenue streams that can be presented in a user interface, such as a user interface 170 associated with computing device 105b, which, in turn, may be associated with a user 105a. User interface 170 and engagement management engine 140 may be configured to facilitate electronic communication among “front office” customer relationship management functions and “back-office” enterprise-related functions, such as billing and revenue recognition that may be used to drive the fiscal health of a business through reports, dashboards (e.g., user interface 170), and automated modification of enterprise processes to, for example, optimize revenue (e.g., recognize revenue). Moreover, user interface 170 and engagement management engine 140 may be configured to provide a centralized way of viewing and monitoring enterprise processes, thereby providing a 360 degree view of products or services an enterprise has to offer, such as professional services, subscriptions, and goods, within specific units of time.

Any of the multiple revenue streams of data may originate from (or may be associated with) data sources providing data representing projects and/or financial rates of services (e.g., resources, such as labor, etc.), data representing licensing or subscription revenue, data representing sales of goods/items/products, or any other source of revenue or enterprise data. Further, any of the multiple revenue streams may be associated with an engagement data object to manage, monitor, and/or modify any enterprise process based on a state of any of the multiple revenue streams (and/or variations of data values thereof).

In at least one example, engagement management engine 140 may be configured to generate an engagement object that can include enterprise-related data that may identify one or more streams of revenue data. According to various embodiments, an engagement and its corresponding data may identify one or more streams of data, each data stream representing revenue originating from any of a number of disparate data sources. As an example, an engagement may include data representing a consolidation of a subset of services, a subset of subscriptions, and/or a subset of products/goods sold, all of which may be integrated or included on a common invoice (e.g., transmitted as an electronic message). An engagement object may include data referencing an account identifier associated with an electronic account (e.g., a specific customer account), whereby at least one individualized revenue stream associated with an engagement may be defined by a start date, end date, and a financial amount.

In the example shown, engagement management engine 140 may be disposed in an enterprise resource computing platform 110, which may include enterprise resource planning (“ERP”) computing logic 120 that may be configured to detect, store, manage, and analyze data from any number of business activities or functions of an enterprise. In some examples, enterprise resource planning (“ERP”) computing logic 120 may include professional services automation (“PSA”) logic 122 that may be configured to facilitate project and resource management, as well as other business processes for professionally-related businesses and services, such as consultants, attorneys, information technologists (“IT” professionals), and the like. Enterprise resource planning (“ERP”) computing logic 120 may include supply chain management computing (“SCM”) logic 123 configured to manage supply chain processes of an enterprise, such as identifying orders, manufacturing or procuring a product, and managing inventory. ERP computing logic 120 may also include financial management (“FM”) computing logic 126 configured to generate and facilitate financial-related functions, such as maintaining general ledger (“GL”) data, accounts payable/receivable (“AP/AR”) data, “billing data,” revenue recognition data, etc. In accordance with at least one implementation, any of ERP computing logic 120, PSA logic 122, SCM logic 123, and FM computing logic 126 may be implemented as logic, platforms, and/or applications maintained by FinancialForce.com, Inc., of San Francisco, Calif., USA.

Enterprise resource planning (“ERP”) computing logic 120 may also include automation computing logic 127 that can be configured to automatically extract one or more of project data, billing data, and supply chain data (and associated metadata) from multiple disparate data sources, any of which may be different software applications, different operating systems, and/or different database repositories. In at least one implementation, automation computing logic 127 may be configured to implement at least a portion of a runbook application (or any other application or programmatic script) that may be configured to automatically access—through runbook automation—any number of disparate data sources from which to retrieve financially-related data for use by engagement management engine 140. Runbook automation may also be implemented to perform any other enterprise function, such as consolidating multiple revenue streams for generating comprehensive invoices that include each of the multiple revenue streams associated with an engagement, as well as managing revenue contracts to comply with rules defining recognized revenue, among other things.

Further, enterprise resource planning (“ERP”) computing logic 120 may be configured to electronically communicate with (e.g., integrated with, or “built on”) customer relationship management (“CRM”) computing logic 124, which may be configured to manage interactions among an enterprise and third party computing devices (e.g., customer devices). In accordance with at least one implementation, customer relationship management (“CRM”) computing logic 124 may be implemented as logic, platforms, and/or applications maintained by Salesforce.com, Inc., of San Francisco, Calif., USA. Any of ERP computing logic 120, PSA logic 122, SCM logic 123, FM computing logic 126, and automation computing logic 127 may be configured to communicate electronically with engagement data model generator 157, an enterprise repository 155, and engagement management engine 140 to exchange data to generate, maintain, and modify data associated with one or more engagement data objects for generating data that is to be presented or displayed as user interface 170, or that is to be used to modify an enterprise process (e.g., automatically).

Note that enterprise repository 155 may be configured to store enterprise-related data, including revenue-related data to populate an engagement data object to include one or more of project data, billing data, and supply chain data. Enterprise repository 155 may be configured to store business function data 107a and financial data 108a in one or more data arrangements in any database technology (e.g., as relational databases, graph databases, etc.). As shown, engagement management engine 140 may be configured to receive or exchange business function data 107a and financial data 108a directly in real time (or near real time) (e.g., via a pipeline or an event-driven architecture, or any other computing or data architecture). Also, engagement management engine 140 may be configured to access business function data 107a and financial data 108a as stored in enterprise repository 155.

Enterprise resource computing platform 110 may be configured to exchange data with enterprise computing devices 105, any of which may be configured to perform or facilitate any number of business functions for an enterprise, such as sales, marketing, project planning, finance, accounting, procurement, inventory management, human resource management, supply chain management, and the like. In this example, computing systems 101b, 102b, 103b, and 104b may be associated with users 101a, 102a, 103a, and 104a, respectively. For example, computing device 101b may be configured to perform sales-related functions via a sales-centric user interface 101c, computing device 102b may be configured to perform finance-related functions via a finance-centric user interface 102c, computing device 103b may be configured to perform project management-related functions via a project-centric user interface 103c, and computing device 104b may be configured to perform supply chain management-related functions via a supply-centric user interface 104c.

Business function-centric user interfaces 101c, 102c, 103c, and 104c may be configured to exchange enterprise data via data streams 111 with enterprise resource computing platform 110 over a network 119, such as the Internet or any other network. Enterprise data streams 111 may include business function data 107a and financial data 108a. In some examples, business function data 107a may include any business-related data associated with data entry fields or user input portions 107 of user interfaces 101c, 102c, 103c, and 104c. As an example, business function data 107a may include data that may be ancillary to aggregation of multiple revenue streams, such as data representing a customer contact name, a sales agent name, etc., as well as notes, comments, and any other unstructured data that may be processed in relation to business function data 107 portions of user interfaces 101c, 102c, 103c, and 104c. Financial function data 108a may include any financially-related data associated with data entry fields or user input portions 108 of user interfaces 101c, 102c, 103c, and 104c, any of data entry fields or user input portions 108 being configurable to identify data 108a in contrast to business function data 107a, which also may be configurable in defining differences in data 107a and 108a, at least in some cases. Financial data 108a may include an account identifier (e.g., to identify a customer), units of time (e.g., start date, end date, etc.), project or service-related data (e.g., costs of implementing a human resource, a machine, or any asset), cost data, subscription data (e.g., amounts to license an item based on units of time), amounts relating manufacturing or delivering one or more items or products via a supply chain, and the like. As an example, financial data 108a may also include data related to recurring revenue, client credit, account balance due, project delivery dates, opportunity and projected revenue based on pre-sale quotes, and any other financial-related information. According to some embodiments, enterprise resource computing platform 110 may be configured to classify data traffic in data streams 111 to distinguish financial data 108a from business function data 107a. As such, financial data 108a may be classified as being exchanged via a financial data channel 109, which may be the same networked electronic path or a different networked electronic path through which business function data 107a is communicated.

Engagement management engine 140 of diagram 100 may be configured to generate a data model that includes any number of engagement data objects, each of which may include one or more of project data, billing data, supply chain data, and the like. Further, engagement management engine 140 may be configured to aggregate subsets of project data, billing data, supply chain data, etc., to aggregate different revenue streams associated with an account (e.g., an engagement with a customer). For example, an electronic account (e.g., a customer-related data arrangement) may be associated with (or linked to) one or more engagement data objects, whereby an engagement data object may include data representing revenue or other financial data associated with an interaction between a customer and an enterprise, such as an agreement or contract to deliver services, provide goods, license usage of a product or service through subscriptions, and the like. Each interaction, or engagement, may represent an exchange of goods or services for units of pecuniary data (e.g., currency-based data), and thus can represent one or more streams of revenue, such as provided by an agreement that an enterprise is obligated to, for example, supply computing display devices, provide services to install the display devices, and activate subscriptions to a number of software products, each of which may provide a distinct revenue stream to the enterprise.

Engagement management engine 140 also may be configured to generate data configured to present aggregated subsets of project data, billing data, and supply chain data in a user interface, such as depicted in user interface 170. Further, engagement management engine 140 may be configured to analyze a pool of data including aggregated subsets of project data, billing data, and supply chain data to detect a variation in one or more data values (e.g., relative to rules or other threshold data values). In response, engagement management engine 140 may be configured to invoke an analytical process and present the variation in user interface 170. Also, engagement management engine 140 may be further configured to generate a command automatically to modify a process performed by an enterprise to optimize, for example, financial goals of an enterprise or organization.

Engagement management engine 140 may include one or more of an engagement calculator 142, a presentation engine 148, a predictive engine 149, and an enterprise process modification controller 141. Engagement calculator 142 may be configured to analyze a pool of data including one or more subsets of one or more of project data, billing data, and supply chain data to generate an engagement dataset. The engagement dataset may include data representing attributes based on one or more aggregated subsets of project data, billing data, and supply chain data. In some examples, attributes that may be aggregated as data by engagement calculator 142 may include revenue of an engagement over multiple revenue sources, invoiced amounts of qualifying data values based on multiple revenue sources, aggregated cost amounts over tasks linked to the engagement, and the like. Also, engagement calculator 142 may be configured to calculate a “margin” over the multiple revenue sources.

Further, engagement calculator 142 may be configured to detect a variation in a data value in a pool of data including aggregated subsets of project data, billing data, and supply chain data, as well as any other enterprise-related data. Also, engagement calculator 142 may be configured to calculate automatically updated values associated with any of the aggregated subsets to update an engagement dataset based on a variation in one or more data values. For example, if an ordered delivery of digital display devices are delayed due to shipping (or any other reason), engagement calculator 142 may be configured to identify other related services or subscriptions that may also be delayed, any of which may affect an aggregated revenue stream of an enterprise. Hence, engagement calculator 142 may be configured to adjust automatically projected revenue expectations responsive to variations in any interaction or obligation (e.g., an “engagement”) among an enterprise, a customer, and a third party. In some examples, engagement data calculated by engagement calculator 142 may be determined based on functionality of enterprise resource computing platform 110 that may be configured to implement, for instance, support vector machines (“SVMs”), various types of neural networks (e.g., convolutional neural networks (“CNN”), recurrent neural networks (“RNN”), artificial neural networks (“ANN”), and the like), various regression techniques, various k-means computations, or any other like algorithms.

Presentation engine 148 may be configured to format or otherwise transform data representing one or more subsets of engagement data (e.g., aggregated engagement data) in various degrees of aggregation or granularity for presentation at, for example, user interface 170, among others. In some examples, presentation engine 148 may include logic to identify revenue-related data, based on data generated by engagement calculator 142, and may be further configured to present aggregated subsets of project data, billing data, and supply chain data. According to some examples, presentation engine 148 may be configured to execute instructions to activate an engagement management dashboard application, a portion of which is depicted in user interface 170. In at least one example, presentation engine 148 may be configured to implement a presentation format for causing display of a certain type of revenue-related data at user interface 170 in a certain display format conducive for managing financial health of an organization, and to identify risk thereto.

In accordance with some examples, presentation engine 148 may be configured to present subsets of aggregated revenue-related data in, for example, one or more interactive portions of user interface 170. As an example, user interface 170 may be configured to receive user input, such as an input derived from an interaction by a graphical selector element 199. Presentation engine 148 may be configured to receive data representing a user input 199 responsive to a user input activated at an interactive portion 171 of user interface 170. Interactive portion 171 of user interface 170 may be configured to receive an input signal to cause generation of a “summary” 190 as shown in diagram 100. In diagram 100, summary data 190 depicts a consolidation of revenue data extracted over multiple streams of revenue data. As shown, revenue data, invoiced data, cost data, and margin data may be depicted by relative amounts from which they are derived, including service-derived data 176a and subscription-derived data 176b, but may include (not shown) other sources of revenue, such as orders of tangible products or goods sold in association with an agreement or an engagement. Further, presentation engine 148 may be configured to generate a user input 172 to identify service-related data, a user input 173 to identify subscription-related data, a user input 174 to identify billing-related data, and a user input 175 configured to generate and present revenue recognition data.

Predictive engine 149 may include logic configured to predict whether one or more events may impact one or more streams of revenue, and, in turn, may be configured to generate one or more courses of actions to modify computerized processes of an enterprise to minimize or negate effects of the one or more events affecting one or more streams of revenue. For example, consider an enterprise that has a revenue contract with a public school district to deliver digital display devices to various public schools at different locations, as well as having obligations to install digital display devices at various geographic locations. Also, a revenue contract may also obligate an enterprise to provide subscriptions (e.g., licensed usage of software) to computing systems at the public schools. In some examples, each of the aforementioned transactions may be represented as data and identified to form an engagement data object, whereby each revenue stream derived from each transaction may be aggregated—from independent sources of revenue data—to generate a centralized view of data representing a comprehensive view of revenue, which may assist in facilitating optimization of operations of an enterprise. An example of a centralized view is depicted in FIGS. 1, 10, and 13, among others.

Next, consider a delayed delivery of the digital display devices, which, in turn, may delay or otherwise impact installation of the devices and activation of subscriptions. Hence, revenue may be impacted, which, in turn, may affect other operations of an enterprise, such as asset purchases, hiring decisions, office expansion, and the like. In some examples, predictive engine 149 may be configured to identify a risk to a revenue stream, such as a delayed shipment of digital display devices, and may be further configured to identify one or more actions that may be implemented automatically to modify computerized processes of an enterprise to counteract or ameliorate the effects of delayed revenue resulting from the delayed shipment of digital display devices. In some examples, revenue may be defined in accordance with the term “recognized revenue” under ASC 606, as jointly developed by the Financial Accounting Standards Board (“FASB”) and the International Accounting Standards Board (“IASB”).

Further, predictive engine 149 may be configured to access data from external data sources 125, as well as internal data sources (e.g., within an enterprise), to determine whether a risk event may exist and may affect revenue across multiple revenue streams from disparate sources. For example, predictive engine 149 may be configured to access via external data sources 125 one or more published news articles. In one example, predictive engine 149 may identify (e.g., through natural language processing, or NLP, etc.) that a particular vendor supplying digital display devices may be entering bankruptcy. In response, predictive engine 149 may generate a data signal to secure another vendor or may be configured otherwise to modify revenue projections based on the potential bankruptcy of the vendor. In some cases, predictive engine 149 may be configured to implement any machine learning algorithm, deep-learning algorithm, or any other predictive algorithm (e.g., Bayesian, etc.), including, but not limited to algorithms implementing support vector machines (“SVMs”), various types of neural networks (e.g., convolutional neural networks (“CNN”), recurrent neural networks (“RNN”), artificial neural networks (“ANN”), and the like), various regression techniques, various k-means computations, or any other like algorithms. In one example, predictive engine 149 may be configured to determine optimized revenue-related data based on analyzing data patterns that may be matched against machine-predicted patterns or against a set of one or more rules.

Enterprise process modification controller 141 may be configured to receive data signals from various components in an engagement management engine 140, and in response, may be further configured to generate command data 141a to cause or invoke one or more computerized enterprise functions (not shown) to adjust for one or more changes or modifications in one or more revenue streams. In some examples, enterprise process modification controller 141 may cause presentation of a user input 191 in user interface 170, whereby activation of user input 191 may implement an automated modification of an enterprise process to optimize an objective, such as maintaining or preserving revenue or other assets. As an example, if engagement management engine 140 determines that a vendor or supplier of digital display devices are on the brink of bankruptcy, enterprise process modification controller 141 may be configured to generate command data 141a including a command to cease or delay any payments to potentially bankrupt vendor or supplier, thereby preserving capital or other resources.

Any of the described elements of FIG. 1, or any other processes described herein, may be implemented as software, hardware, firmware, circuitry, or a combination thereof. Further, any of elements of FIG. 1 may be centralized or may be distributed among any cloud-based computing systems.

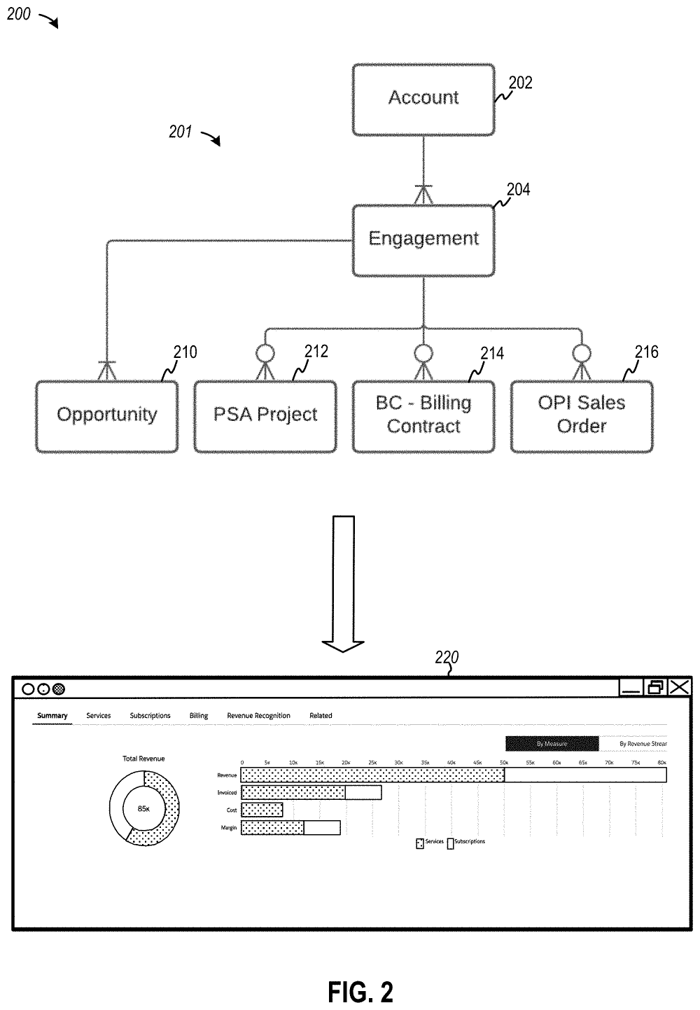

FIG. 2 illustrates an exemplary implementation of an engagement data object, according to some examples. Diagram 200 depicts an example of an engagement data object 201, according to at least some embodiments. As shown, an engagement data object 204 may be linked to, or otherwise associated with, electronic account data 202 (or an identifier thereof). Further, an engagement data object 204 may include data associated with one or more opportunity objects 210, each of which 210 may include data representing a potential lead or customer name, a quoted monetary amount, an associated currency (e.g., a British Pound), a payment plan or timeline of payments, a name of a project or product for which a quote may be sought, and any other information associated with pre-sales activity including a “notes” section or data entry field.

Engagement data object 204 may include data from one or more project data objects 212, one or more billing contract data objects 214, and one or more sales order data objects 216. A project data object (“PSA Project”) 212 may be configured to include data representing assignment of one or more resources (e.g., human resources, tangible assets, etc.) to perform one or more project tasks. Also, project data object 212 may include revenue-related data, such as invoice data and cost data, as well as billing rate data (e.g., timecard information, including time worked) and timing data reflecting milestones at which discrete units of work or tasks may be billed.

A billable contract data object (“BC Billing Contract”) 214 may be configured to include data representing contract identifiers, revenue and invoicing information. A sales order data object (“OPT Sales Order”) 216 may be configured to include data representing sales order items (e.g., a number of digital display devices, etc.), revenue, invoicing information, and costs, among other items. As shown, engagement data object 204 may be accessed and processed to generate a user interface 220.

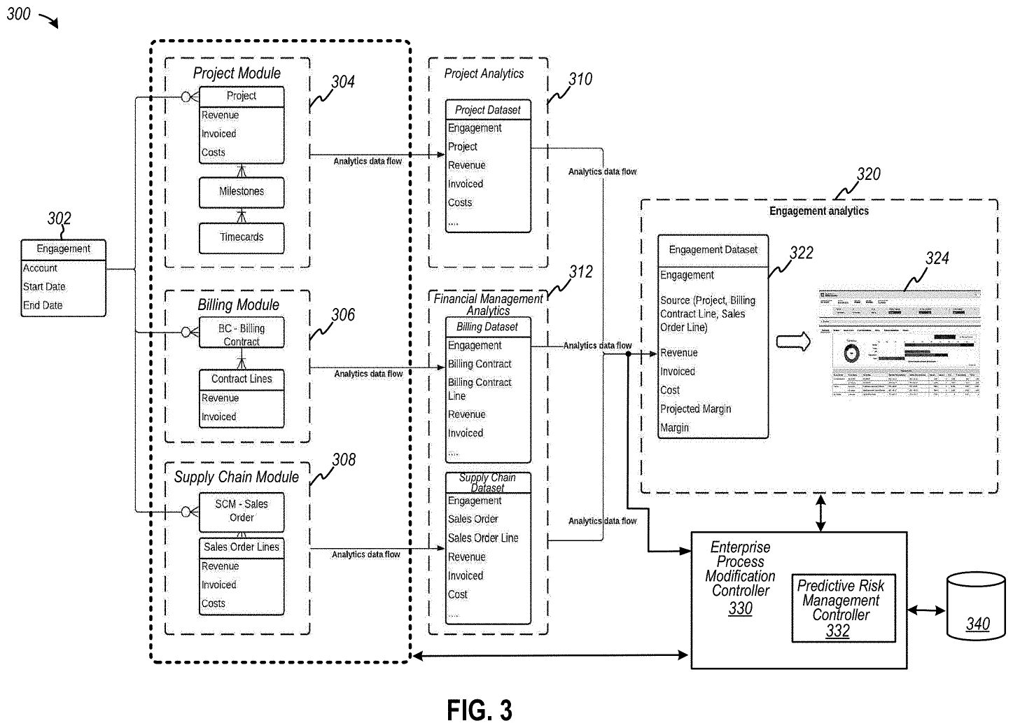

FIG. 3 is a diagram depicting an example of architecture implementing an engagement management engine to generate and implement a data aggregation model for managing engagement data objects and adapting computerized enterprise data flows, according to some examples. Diagram 300 includes an engagement data object 302 and a project computing module 304 configured to identify and populate a first portion of a data model, a billing computing module 306 configured to identify and populate a second portion of a data model, and a supply chain computing module 308 configured to identify and populate a third portion of a data model. Also, project computing module 304, billing computing module 306, and supply chain computing module 308 may be configured to generate a project dataset, a billing dataset, and a supply chain dataset, respectively.

Diagram 300 also depicts project analytics logic 310 configured to analyze and process a project dataset, and financial management analytics logic 312 that may be configured to analyze and process a billing dataset and a supply chain dataset. Data output from project analytics logic 310 and financial management analytics logic 312 may be used to generate an engagement dataset 322, which may be analyzed and processed by engagement analytics logic 320 to, for example, generate data for presentation as a user interface 324.

In some examples, project computing model 304 (and optionally project analytics logic 310) may implement professional services automation (“PSA”) software applications, billing computing module 306 may implement “Billing Central” software applications, supply chain computing module 308 may implement “Supply Chain Management” software application, and financial management analytics logic 312 may implement “Financial Management (‘FM’)” software applications, each software application being developed and provided by FinancialForce.com, Inc., of San Francisco, Calif.

Enterprise process modification controller 330 may be configured to receive data of an engagement dataset 322, user input control data signals generated at user interface 324, and enterprise data stored in repository 340. Enterprise process modification controller 330 may be configured to cause generation of a command configured to modify automatically an enterprise process responsive to a variation in a data value, such as an amount of deficient revenue, detection of an unpaid invoice, determination that a resource is unavailable to perform a task, and the like. Further, enterprise process modification controller 330 may be configured to aggregate a classification of data (e.g., revenue, costs, etc.) from one or more sources of project data, billing data, and supply chain data to form an aggregated dataset. An aggregated dataset may be displayed user interface 324, whereby the aggregated dataset may include revenue data aggregated from project data, billing data, and/or supply chain data.

Enterprise process modification controller 330 may also include logic to implement a predictive risk management controller 332, which may be configured predict deviations in, for example, revenue based on data received from any source, including external data. In one example, predictive risk management controller 332 may be configured to identify external data indicating (e.g., through a news-based website) that a customer may be entering bankruptcy. As such, predictive risk management controller 332 may be configured to automatically determine other sources of revenue or enterprise processes that may be configurable to offset a possible loss of stream of revenue from a potentially bankrupt customer. Predictive risk management controller 332 configured to implement any machine learning algorithm, deep-learning algorithm, or any other predictive algorithm (e.g., Bayesian, linear regression, etc.).

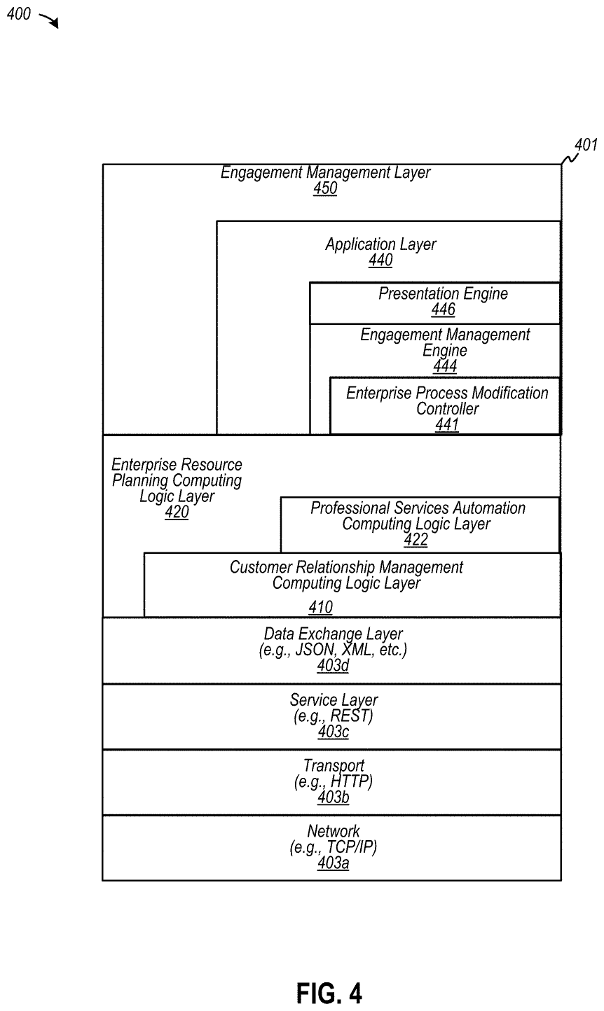

FIG. 4 illustrates an exemplary layered architecture for implementing an engagement management engine application, according to some examples. Diagram 400 depicts application stack (“stack”) 401, which is neither a comprehensive nor a fully inclusive layered architecture for managing and processing engagement data. One or more elements depicted in diagram 400 of FIG. 4 may include structures and/or functions as similarly-named or similarly-numbered elements depicted in other drawings, or as otherwise described herein, in accordance with one or more examples, such as described relative to FIGS. 1 to 3, or any other figure or description herein.

Application stack 401 may include an engagement management layer 450 upon an enterprise resource planning computing logic layer 420, which, in turn, may be disposed upon any number of lower layers (e.g., layers 403a to 403d). Enterprise resource planning computing logic layer 420 may be disposed on data exchange layer 403d, which may implemented using any programming language, such as HTML, JSON, XML, etc., or any other format to effect generation and communication of requests and responses among computing devices and computational resources constituting an enterprise and an enterprise resource planning application and/or platform. Data exchange layer 403d may be disposed on a service layer 403c, which may provide a transfer protocol or architecture for exchanging data among networked applications. For example, service layer 403c may provide for a RESTful-compliant architecture and attendant web services to facilitate GET, PUT, POST, DELETE, and other methods or operations. In other examples, service layer 403c may provide, as an example, SOAP web services based on remote procedure calls (“RPCs”), or any other like services or protocols. Service layer 403c may be disposed on a transport layer 403b, which may include protocols to provide host-to-host communications for applications via an HTTP or HTTPS protocol, in at least this example. Transport layer 403b may be disposed on a network layer 403a, which, in at least this example, may include TCP/IP protocols and the like. Note that in accordance with some examples, layers 403a to 403d facilitate implementation of a risk management data channel as set forth herein.

Enterprise resource planning computing logic layer 420 may be configured to detect, store, manage, and analyze data from any number of business activities or functions of an enterprise. As shown, enterprise resource planning computing logic layer 420 may include a professional services automation computing logic layer 422 that may be configured to facilitate project and resource management, and to provide other business-related functionality. Enterprise resource planning computing logic layer 420 may also be configured to provide functionality to manage various business functions, such as sales, pre-sale opportunity development, accounting, billing, revenue recognition, procurement, inventory management, project management, human capital management (“HCM”), supply chain management (“SCM”), among various other business functions. Enterprise resource planning computing logic layer 420 may implement also a Billing Central (“BC”) software application, and a Financial Management (“FM”) software application.

In at least one example, enterprise resource planning computing logic layer 420 and professional services automation computing logic layer 422 may be implemented as logic, platforms, and/or applications maintained by FinancialForce.com, Inc., of San Francisco, Calif., USA. In some examples, enterprise resource planning computing logic layer 420 and professional services automation computing logic layer 422 may be layered upon a customer relationship management computing logic layer 410, which may be configured to manage interactions among an enterprise and third party entities and computing devices. An example of functionality provided at customer relationship management computing logic layer 410 may include CRM-related logic, platforms, and/or applications maintained by Salesforce.com, Inc., of San Francisco, Calif., USA. In accordance with some examples, layers 420, 422, and 410 may include communication layers (e.g., application programming interface, or “API,” layers). Examples of APIs or other communicative applications may include any code-based data connector that may facilitate communication throughout application stack 401 and external thereto. Layers 420, 422, and 410 may also include business components and a process and/or application builder, both of may be implemented as Lightning components and Lightning App Builder (e.g., as maintained by Salesforce.com, Inc.), or as any other component or application builder.

As shown, risk management layer 450 may be disposed on or otherwise built on layers 420, 422, and 410, and provides risk management functionality as described herein. Further to diagram 400, engagement management layer 450 may include (or may be layered upon) an application layer 440 that includes logic constituting a presentation engine layer 446 configured to generate data for presentation in a user interface, an engagement management engine layer 444, and an enterprise process modification controller layer 441. Engagement management engine layer 444 may be configured to provide functionality as described herein.

Any of the described layers of FIG. 4 or any other processes described herein in relation to other figures may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including, but not limited to, Python™, ASP, ASP.net, .Net framework, Ruby, Ruby on Rails, C, Objective C, C++, C#, Adobe® Integrated Runtime™ (Adobe® AIR™) ActionScript™, Flex™, Lingo™, Java™, JSON, Javascript™, Ajax, Perl, COBOL, Fortran, ADA, XML, MXML, HTML, DHTML, XHTML, HTTP, XMPP, PHP, and others, including SQL™, SPARQL™, Turtle™, etc., as well as any proprietary application and software provided or developed by FinancialForce.com, Inc. or Salesforce.com, Inc. The above described techniques may be varied and are not limited to the embodiments, examples or descriptions provided.

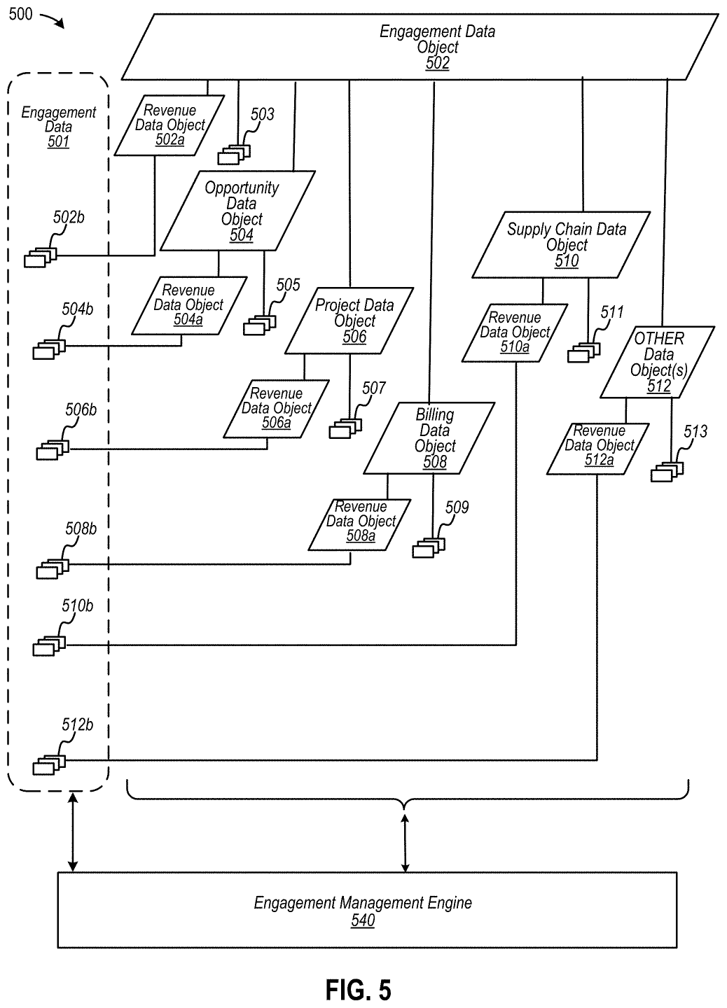

FIG. 5 is a diagram depicting an example of an aggregated data model with which an engagement management engine may identify and analyze business functions based on levels of revenues (and/or risk thereto), according to some embodiments. Diagram 500 depicts a data model at which an engagement data object 502 may be configured to be a hierarchical data object (e.g., a parent data object), under which other business function-related data object may be related. For example, account data object 502 may include or refer to an opportunity data object 504, a project data object 506, a billing data object 508, a supply chain data object 510, and “other” one or more data objects 512 that may related to any other type of business data and business data objects. Each of data objects 502 to 512 may include (or link to) a subsidiary revenue-related data object (or “revenue data object”), such as data objects 502a to 512a, whereby each revenue data object may be associated with data originating or associated sources of revenue. Thus, revenue data 502b to 512b may be aggregated to form engagement data 501. In some examples, data model of diagram 500 may be generated in engagement data model generator 157 of FIG. 1.

Engagement data object 502 may include account business function 503 with start and end dates of an engagement. Further, opportunity data object 504 may include data 505 representing a potential lead or customer name, a quoted monetary amount, an associated currency (e.g., a British Pound), a payment plan or timeline of payments, a name of a project or product for which a quote may be sought, and other pre-sales activities. Project data object 506 may include data 507 representing a resource planner, names of persons who are associated with a project, project costs, timelines, projected milestones, etc. Billing data object 508 may include data 509 representing any of a total revenue for one or more accounts, engagements and/or contracts (e.g., revenue contracts), recognized revenue, average annual recurring revenue or AARR based on subscriptions, accounts receivable amounts, and other financial-related data. Supply chain data object 510 may include data 511 that includes product or service information, asset information to perform a project, and other supply and ordering information. The “other” one or more data objects 512 may include any enterprise-related data 513.

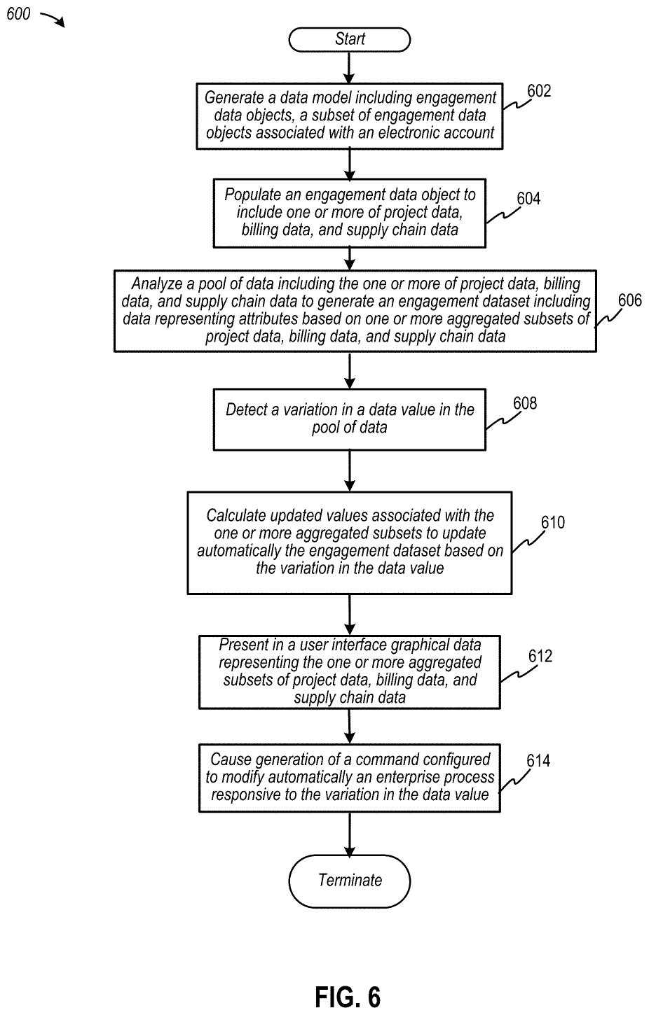

FIG. 6 is a diagram depicting a flow diagram as an example of implementing an aggregated data model including engagement data objects with which an engagement management engine may use to control enterprises processes, according to some embodiments. Flow 600 begins at 602, at which a data model including engagement data objects may be generated. A subset of engagement data objects may be associated with an electronic account associated with one or more engagement data objects. At 604, an engagement data object may be populated to include one or more of project data, billing data, and supply chain data. At a pool of data including the one or more of project data, billing data, and supply chain data may be analyzed to generate an engagement dataset. The engagement dataset may include data representing attributes based on one or more aggregated subsets of project data, billing data, and supply chain data. In some examples, attributes that may be aggregated as data may include revenue of an engagement over multiple revenue sources, invoiced amounts of qualifying data values based on multiple revenue sources, aggregated cost amounts over tasks linked to the engagement, and the like. Also, an attribute may include data representing a “margin” over multiple revenue sources.

At 606, a variation in a data value in the pool of data may be directed. For example, a cost may change, a contract may be canceled, a project task may slip or become delayed, thereby modifying a time frame in which revenue may be recognized (e.g., in accordance with ASC 606 or the like). At 608, updated values associated with the one or more aggregated subsets may be calculated automatically to update an engagement dataset based on a variation in a data value. At 610, a user interface may present graphical data representing one or more aggregated subsets of project data, billing data, and supply chain data, whereby the data can include modify or changed data values responsive to a variation in a data value. At 612, a command configured to modify automatically an enterprise process can be generated responsive to a variation in a data value.

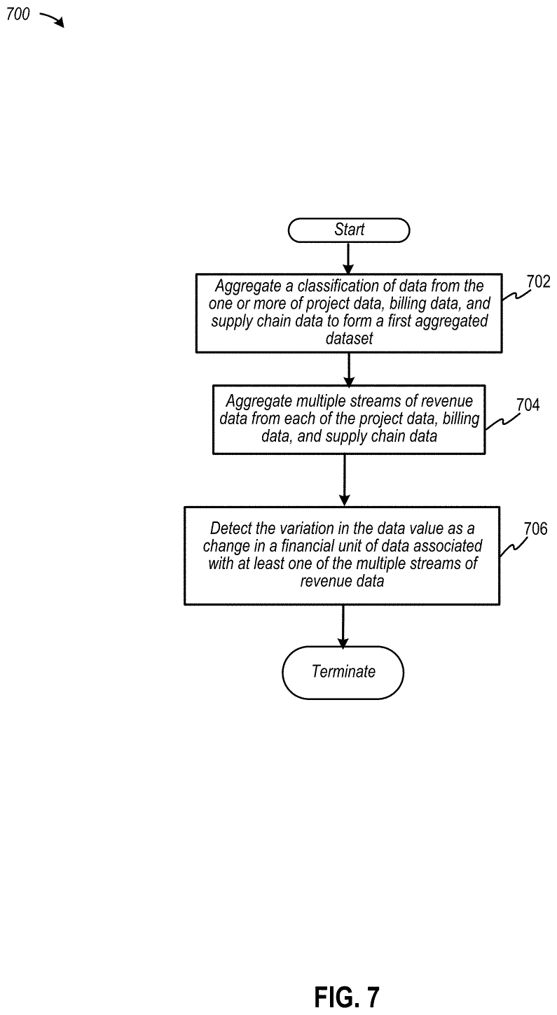

FIG. 7 is a diagram depicting a flow diagram configured to aggregate revenue data, according to some embodiments. Flow 700 begins at 702, at which a type of data may be classified and aggregated using the classified data from one or more of project data, billing data, and supply chain data to form an aggregated dataset. In some examples, an aggregated dataset includes data classified as aggregated revenue data, aggregated costs, aggregated invoice data, margin data, etc. At 704, multiple streams of revenue data from each of the project data, billing data, and supply chain data can be aggregated to form a collective revenue stream. At 706, a variation in the data value as a change in a financial unit of data associated with at least one of the multiple streams of revenue data

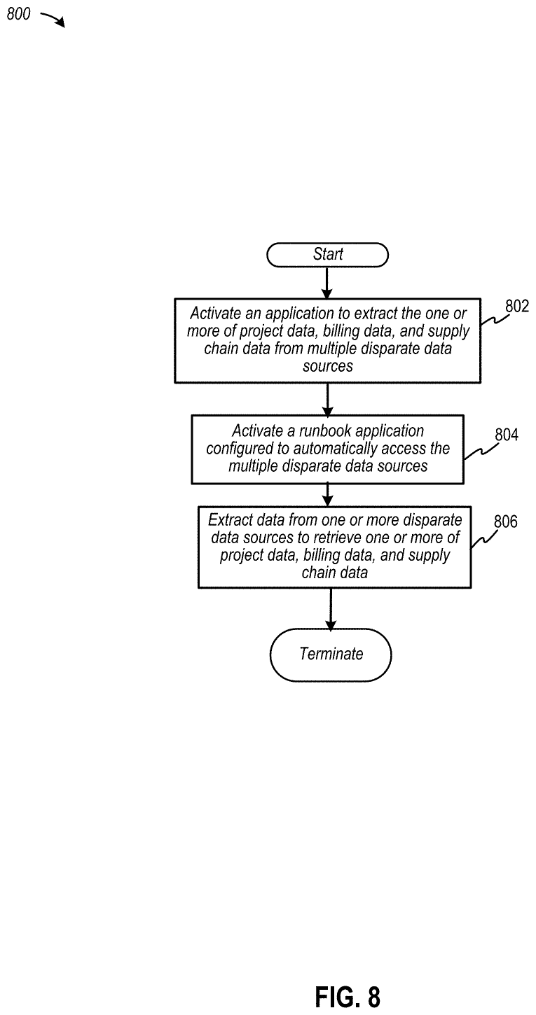

FIG. 8 is a diagram depicting a flow diagram to implement an automated application to form an aggregated data model, according to some embodiments. Flow 800 begins at 802, at which an application may be activated to extract from multiple disparate data sources one or more of subsets of data from project data, billing data, and supply chain data. At 804, activation of an automated application may include activating a runbook application configured to automatically access multiple disparate data sources (e.g., different software applications and/or repositories). At 806, using a runbook application, data may be extracted automatically from one or more disparate data sources to retrieve one or more of project data, billing data, and supply chain data to form aggregated subsets of data.

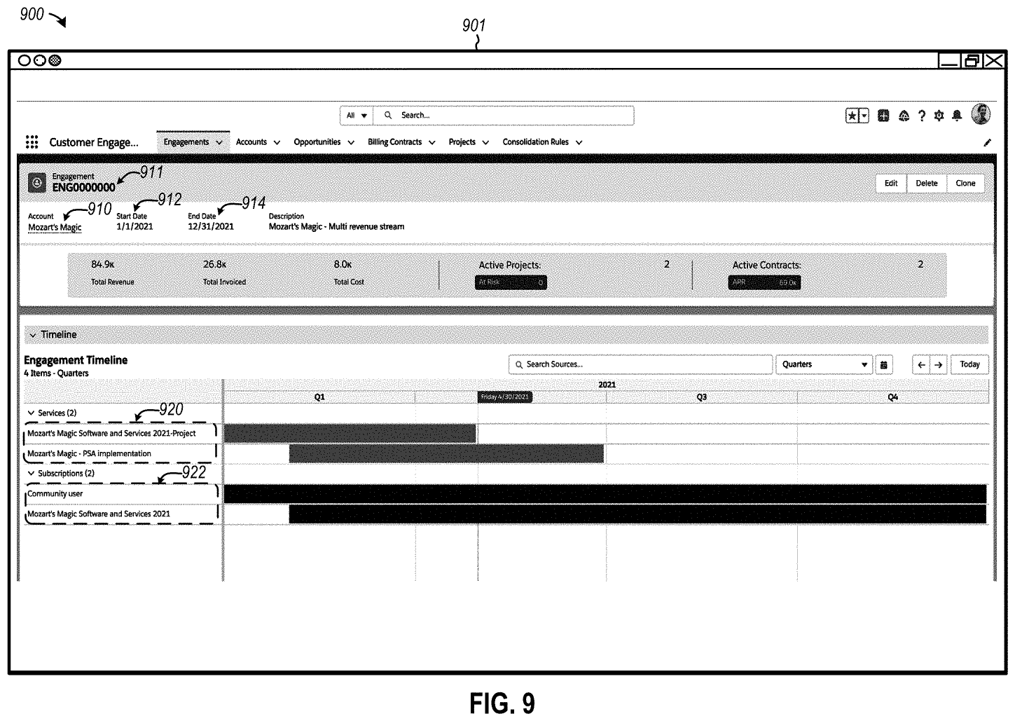

FIG. 9 is a diagram depicting an example of an enterprise management engine configured to cause generation of a dashboard in a user interface, according to some examples. Diagram 900 depicts a user interface 901 in accordance with one or more techniques and/or processes described herein. As shown, an engagement data object associated with engagement (“ENG0000000”) 911 may also provide an account name 910, an engagement start data 912, and an engagement end data 914. Further, diagram 900 may depict an engagement timeline view, which may provide a comprehensive view of when services 920 and subscriptions 922 begin based on start dates, and projects start and end dates so users may have visibility of target dates of the engagement. Users can proactively identify renewal and churn risks by monitoring an entire lifecycle of interactions with a specific customer.

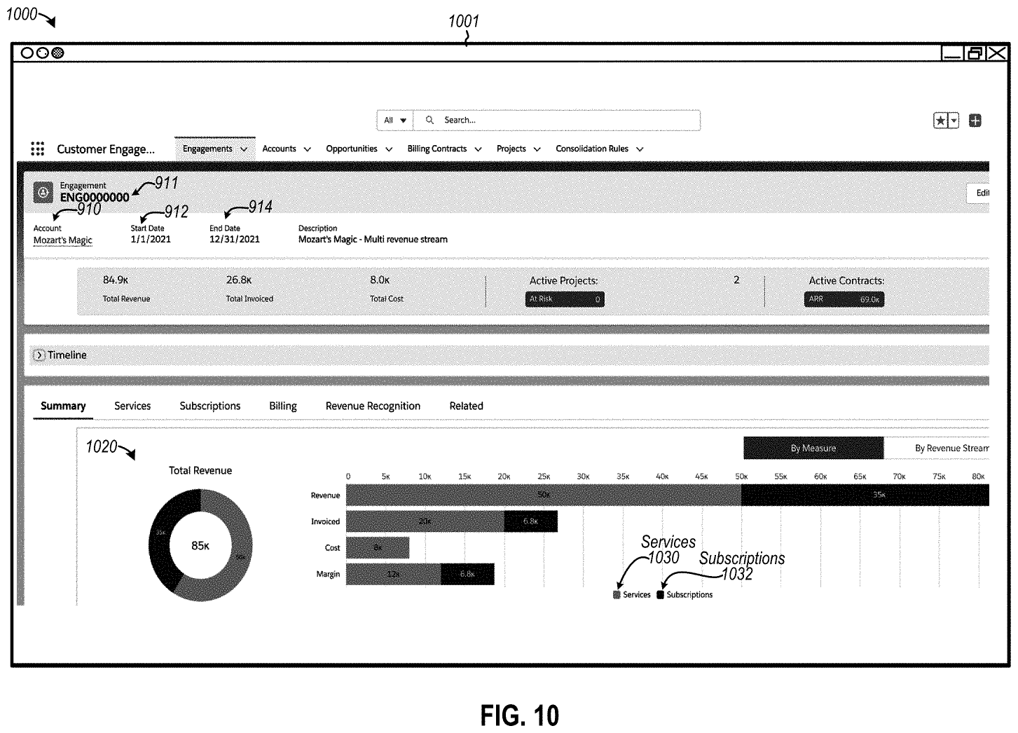

FIG. 10 is a diagram depicting an example of an enterprise management engine configured to cause generation of a dashboard in a user interface, according to some examples. Diagram 1000 depicts a user interface 1001 in accordance with one or more techniques and/or processes described herein. As shown, an engagement data object associated with engagement (“ENG0000000”) 911 may aggregated data, such as revenue data, based on an aggregation of service-based revenue 1030, and an aggregation of subscription-based revenue 1032. In some cases, user interface 1001 may be viewed as an engagement summary 1020 to provide total or aggregated revenue for an engagement. Also, user interface 1001 may present invoiced revenue, total costs, and predicted margin. Users may access electronic transaction documents to view or retrieve data regarding projects, services, and subscriptions. The revenue, costs and margin may break down further by each revenue stream, and users can drill down into each revenue stream to see revenue detail.

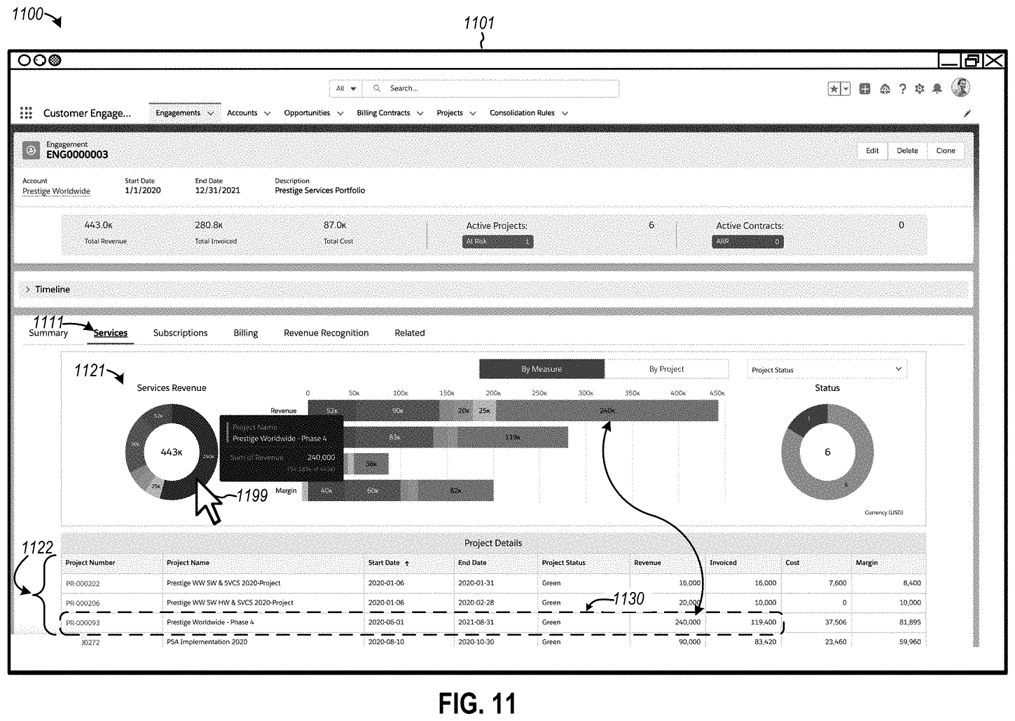

FIG. 11 is a diagram depicting an example of an enterprise management engine configured to cause generation of a dashboard in a user interface, according to some examples. Diagram 1100 depicts a user interface 1101 in accordance with one or more techniques and/or processes described herein. With activation of user input 1111, a user interface portion 1121 may display aggregated services revenue. Further, a user input 1199 may be configured to cause presentation of a granular view of project data, including references to project numbers 1122, such as depicted for project 1130. User interface portion 1121 provides a view, for example, to project managers to present a portfolio of view of projects being implemented (i.e., a “Portfolio of Projects”). Project managers may link projects to each other, and view profitability by customer. Embedded analytics may allow users to interact with data and gain a deeper understanding of factors that influence profitability.

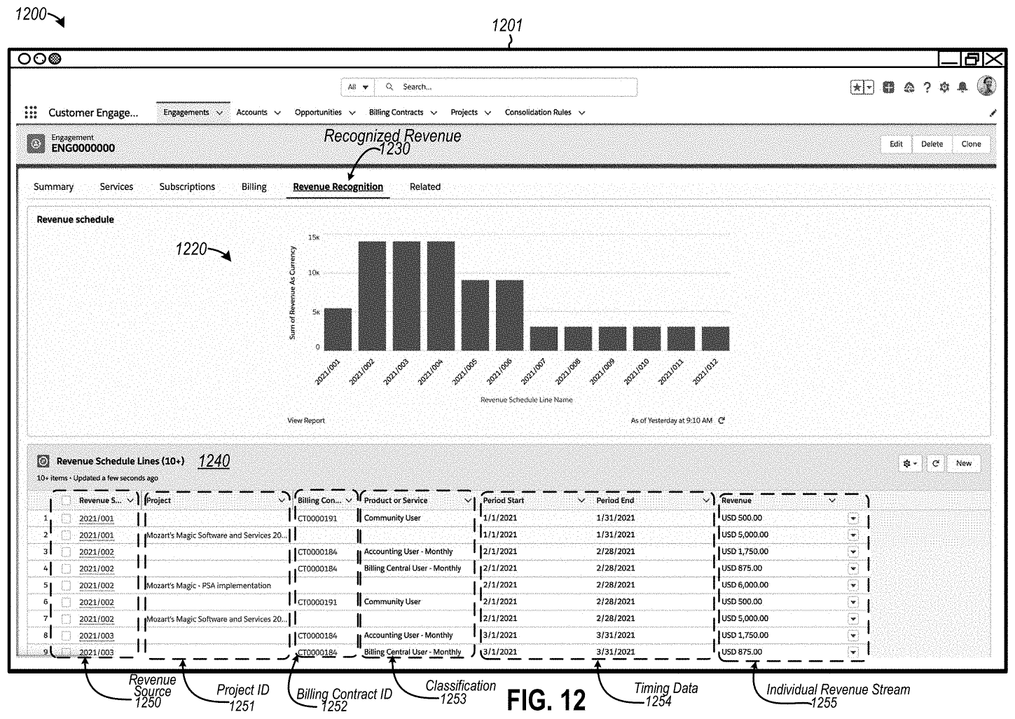

FIG. 12 is a diagram depicting an example of an enterprise management engine configured to cause generation of a dashboard in a user interface, according to some examples. Diagram 1200 depicts a user interface 1201 in accordance with one or more techniques and/or processes described herein. With activation of user input 1230, a user interface portion 1220 may display a schedule of recognized revenue for a selectable time frame for an engagement (and associated engagement data object). Further, a user interface portion 1240 may be configured to cause presentation of a granular view of sources of revenue for an engagement. As shown, user interface portion 1240 may present revenue source data 1250, project identification data 1251, billing contract identification data 1252, product or service classification data 1253, and associated individual revenue streams 1255.

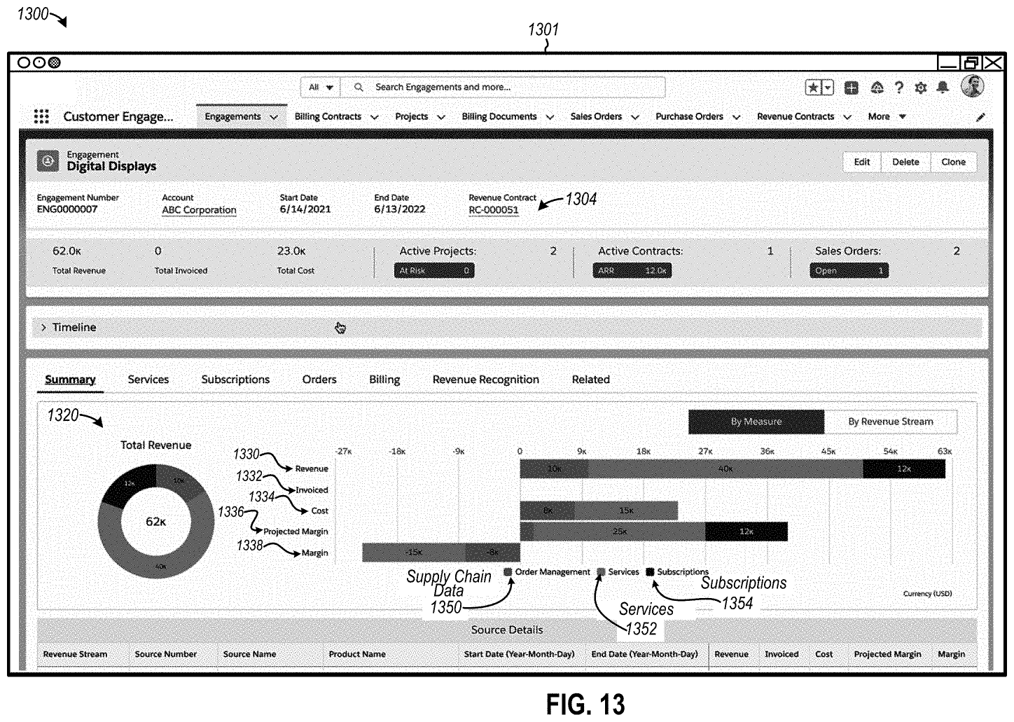

FIG. 13 is a diagram depicting an example of an enterprise management engine configured to cause generation of a dashboard in a user interface, according to some examples. Diagram 1300 depicts a user interface 1301 in accordance with one or more techniques and/or processes described herein. As shown, user interface portion 1320 presents an aggregation of revenue associated with a revenue contract 1304 of an engagement. Further, user interface portion 1320 depicts aggregated revenue 1330, aggregated invoice the data 1332, an aggregation of costs 1334, projected margins 1336, and actual margins 1338, each of which may be derived by aggregating supply chain data values 1350, aggregating services data values 1352, and aggregating subscriptions data values 1354. In this example, an engagement data object identifies engagement number “ENG0000007” for a project of purchasing and installing digital display devices at different locations, as well as selling products or software as, for example, subscriptions.

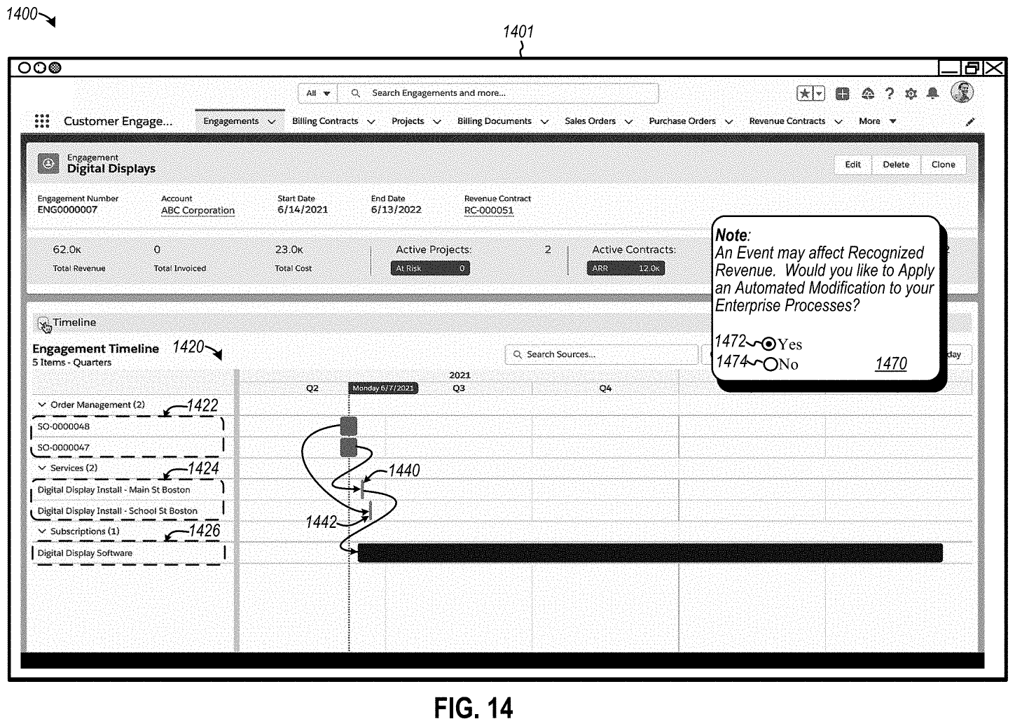

FIG. 14 is a diagram depicting an example of an enterprise management engine configured to cause generation of a dashboard in a user interface depicting an engagement timeline and item interactivity, according to some examples. Diagram 1400 depicts a user interface 1401 in accordance with one or more techniques and/or processes described herein. As shown, user interface portion 1420 presents an engagement timeline based on sales order data 1422, services data 1424, and subscriptions data 1426. Sales order data 1422 is shown to include two (2) sources of revenue (e.g., sale of digital displays), services data 1424 is shown to include two (2) sources of revenue (e.g., based on labor to install digital displays), and subscriptions data 1426 is shown to include one (1) source of revenue (e.g., based on subscriptions of digital display software applications).

In one example, a presentation engine (not shown) may be configured to generate data representing a user interface structured to include at least a first user interface portion configured to activate a first user input to identify one or more sources of revenue data originating at multiple disparate data sources. Referring to FIG. 11, a first user input may be user input 1111, which may be configured to cause computation of data values to present services data to a user. Further, user input 1199 may be configured in a second user interface portion to activate a second user input to identify an aggregated amount of revenue based on one or more sources of revenue associated with an electronic account.

Referring back to FIG. 14, consider an engagement management engine (not shown) detects an impact to engagement timeline 1420. For example, consider an installation technician has fallen ill and causes a delay of installation of display devices to shift from a parallel installation with task 1440 to a serial installation as task 1442. An enterprise process modification controller (not shown) may be configured to automatically analyze factors causing the delay to predict an impact to revenue and its recognition, and may be further configured to automatically implement a modification to one or more processes of the enterprise to negate or reduce effects of the delay to preserve revenue. For example, an enterprise process modification controller may be configured to generate invoices for other customers earlier, or may be further configured to postpone costs associated with purchasing digital display devices. Further, an enterprise process modification controller may perform any modification to any operation of an enterprise.

In one example, presentation engine (not shown) may be configured to generate data representing a user interface structured to include at least a third user interface portion configured to activate implementation of the command to modify automatically the enterprise process. As shown, user interface 1401 may include an interface portion 1470 to present user inputs 1472 and 1474 to implement an automated modification to an enterprise process.

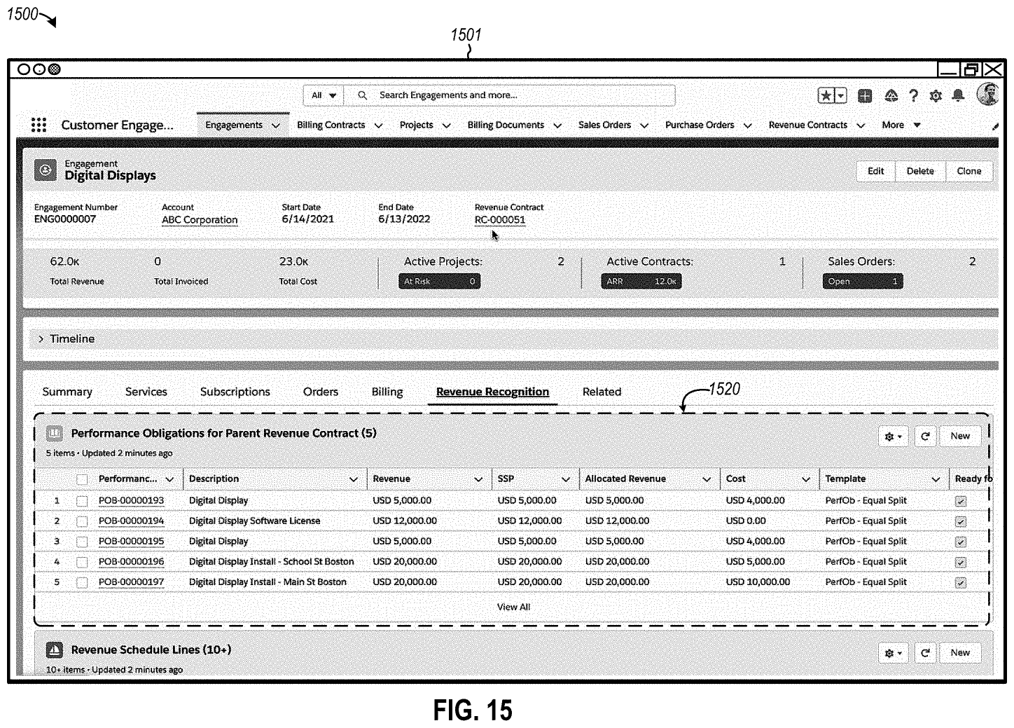

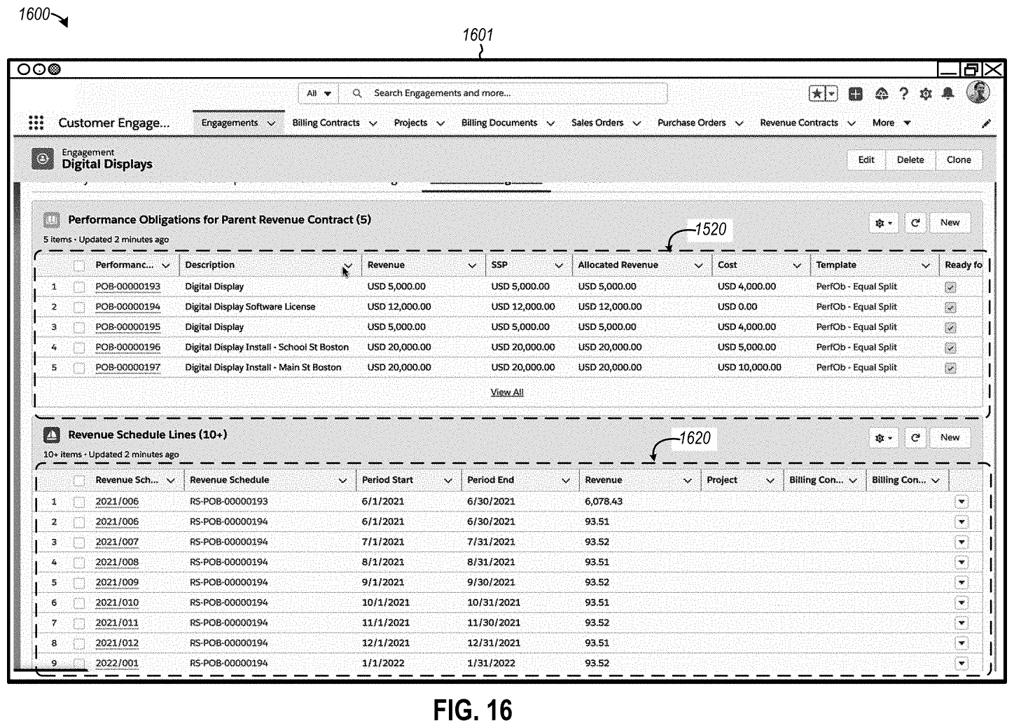

FIGS. 15 and 16 are diagrams depicting examples of an engagement management engine configured to present engagement-related data, according to some examples. Diagram 1500 depicts a user interface 1501 in accordance with one or more techniques and/or processes described herein. As shown, a user interface portion 1520 presents a number of performance obligations for a revenue contract associated with an engagement. Diagram 1600 depicts a user interface 1601 in accordance with one or more techniques and/or processes described herein. As shown, user interface portion 1520 presents a number of performance obligations for a revenue contract associated with an engagement, and a user interface portion 1620 may be configured to present lines of a revenue schedule.

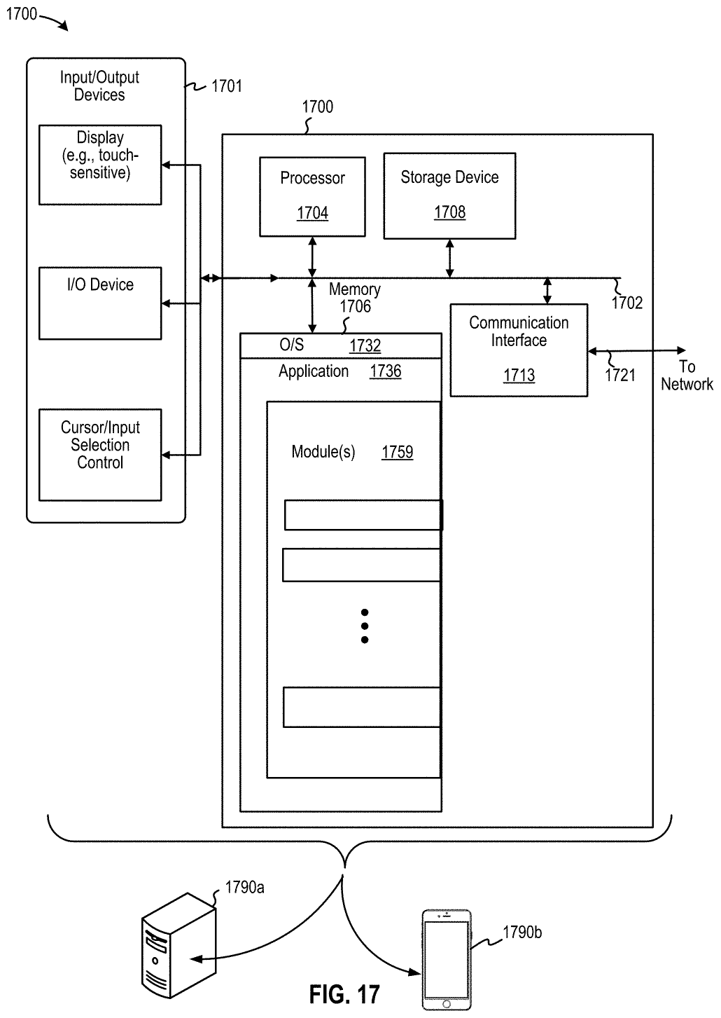

FIG. 17 illustrates examples of various computing platforms configured to generate and implement a data aggregation model to manage engagement data objects and adapt computerized enterprise data flows, according to various embodiments.

In some examples, computing platform 1700 may be used to implement computer programs, applications, methods, processes, algorithms, or other software, as well as any hardware implementation thereof, to perform the above-described techniques.

In some cases, computing platform 1700 or any portion (e.g., any structural or functional portion) can be disposed in any device, such as a computing device 1790a, mobile computing device 1790b, and/or a processing circuit in forming structures and/or functions of an above-described apparatus, system, platform or device, according to various examples described herein.

Computing platform 1700 includes a bus 1702 or other communication mechanism for communicating information, which interconnects subsystems and devices, such as processor 1704, system memory 1706 (e.g., RAM, etc.), storage device 1708 (e.g., ROM, etc.), an in-memory cache (which may be implemented in RAM 1706 or other portions of computing platform 1700), a communication interface 1713 (e.g., an Ethernet or wireless controller, a Bluetooth controller, NFC logic, etc.) to facilitate communications via a port on communication link 1721 to communicate, for example, with a computing device, including mobile computing and/or communication devices with processors, including database devices (e.g., storage devices configured to store atomized datasets, including, but not limited to triplestores, etc.). Processor 1704 can be implemented as one or more graphics processing units (“GPUs”), as one or more central processing units (“CPUs”), such as those manufactured by Intel® Corporation, or as one or more virtual processors, as well as any combination of CPUs and virtual processors. Computing platform 1700 exchanges data representing inputs and outputs via input-and-output devices 1701, including, but not limited to, keyboards, mice, audio inputs (e.g., speech-to-text driven devices), user interfaces, displays, monitors, cursors, touch-sensitive displays, LCD or LED displays, and other I/O-related devices.

Note that in some examples, input-and-output devices 1701 may be implemented as, or otherwise substituted with, a user interface in a computing device associated with a user account identifier in accordance with the various examples described herein.

According to some examples, computing platform 1700 performs specific operations by processor 1704 executing one or more sequences of one or more instructions stored in system memory 1706, and computing platform 1700 can be implemented in a client-server arrangement, peer-to-peer arrangement, or as any mobile computing device, including smart phones and the like. Such instructions or data may be read into system memory 1706 from another computer readable medium, such as storage device 1708. In some examples, hard-wired circuitry may be used in place of or in combination with software instructions for implementation. Instructions may be embedded in software or firmware. The term “computer readable medium” refers to any tangible medium that participates in providing instructions to processor 1704 for execution. Such a medium may take many forms, including but not limited to, non-volatile media and volatile media. Non-volatile media includes, for example, optical or magnetic disks and the like. Volatile media includes dynamic memory, such as system memory 1706.

Known forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can access data. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1702 for transmitting a computer data signal.

In some examples, execution of the sequences of instructions may be performed by computing platform 1700. According to some examples, computing platform 1700 can be coupled by communication link 1721 (e.g., a wired network, such as LAN, PSTN, or any wireless network, including WiFi of various standards and protocols, Bluetooth®, NFC, Zig-Bee, etc.) to any other processor to perform the sequence of instructions in coordination with (or asynchronous to) one another. Computing platform 1700 may transmit and receive messages, data, and instructions, including program code (e.g., application code) through communication link 1721 and communication interface 1713. Received program code may be executed by processor 1704 as it is received, and/or stored in memory 1706 or other non-volatile storage for later execution.

In the example shown, system memory 1706 can include various modules that include executable instructions to implement functionalities described herein. System memory 1706 may include an operating system (“O/S”) 1732, as well as an application 1736 and/or logic module(s) 1759. In the example shown, system memory 1706 may include any number of modules 1759, any of which, or one or more portions of which, can be configured to facilitate any one or more components of a computing system (e.g., a client computing system, a server computing system, etc.) by implementing one or more functions described herein.

The structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, modules 1759, or one or more of their components, or any process or device described herein, can be in communication (e.g., wired or wirelessly) with a mobile device, such as a mobile phone or computing device, or can be disposed therein.

In some cases, a mobile device, or any networked computing device (not shown) in communication with one or more modules 1759 or one or more of its/their components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, modules 1759 or one or more of its/their components, or any process or device described herein, can be implemented in one or more computing devices (i.e., any mobile computing device, such as a wearable device, such as a hat or headband, or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, modules 1759 or one or more of its/their components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

As used herein, “system” may refer to or include the description of a computer, network, or distributed computing system, topology, or architecture using various computing resources that are configured to provide computing features, functions, processes, elements, components, or parts, without any particular limitation as to the type, make, manufacturer, developer, provider, configuration, programming or formatting language, service, class, resource, specification, protocol, or other computing or network attributes. As used herein, “software” or “application” may also be used interchangeably or synonymously with, or refer to a computer program, software, program, firmware, or any other term (e.g., engine) that may be used to describe, reference, or refer to a logical set of instructions that, when executed, performs a function or set of functions within a computing system or machine, regardless of whether physical, logical, or virtual and without restriction or limitation to any particular implementation, design, configuration, instance, or state. Further, “platform” may refer to any type of computer hardware (hereafter “hardware”) or software, or any combination thereof, that may use one or more local, remote, distributed, networked, or computing cloud (hereafter “cloud”)-based computing resources (e.g., computers, clients, servers, tablets, notebooks, smart phones, cell phones, mobile computing platforms or tablets, and the like) to provide an application, operating system, or other computing environment, such as those described herein, without restriction or limitation to any particular implementation, design, configuration, instance, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, or state) may be used for processing and/or storage of varying quantities, types, structures, and formats of data, without restriction or limitation to any particular implementation, design, or configuration.

As used herein, data may be stored in various types of data structures including, but not limited to databases, data repositories, data warehouses, data stores, or other data structures configured to store data in various computer programming languages and formats in accordance with various types of structured and unstructured database schemas such as SQL, MySQL, NoSQL, DynamoDB™, etc. Also applicable are computer programming languages and formats similar or equivalent to those developed by data facility and computing providers such as Amazon® Web Services, Inc. of Seattle, Wash., FMP, Oracle®, Salesforce.com, Inc., or others, without limitation or restriction to any particular instance or implementation. DynamoDB™, Amazon Elasticsearch Service, Amazon Kinesis Data Streams (“KDS”)™, Amazon Kinesis Data Analytics, and the like, are examples of suitable technologies provide by Amazon Web Services (“AWS”).

Further, references to databases, data structures, or any type of data storage facility may include any embodiment as a local, remote, distributed, networked, cloud-based, or combined implementation thereof. For example, social networks and social media (hereafter “social media”) using different types of devices may generate (i.e., in the form of posts (which is to be distinguished from a POST request or call over HTTP) on social networks and social media) data in different forms, formats, layouts, data transfer protocols, and data storage schema for presentation on different types of devices that use, modify, or store data for purposes such as electronic messaging, audio or video rendering, content sharing, or like purposes. Data may be generated in various formats such as text, audio, video (including three dimensional, augmented reality (“AR”), and virtual reality (“VR”), or others, without limitation, for use on social networks, social media, and social applications (hereafter “social media”) such as Twitter® of San Francisco, Calif., Snapchat® as developed by Snap® of Venice, Calif., Messenger as developed by Facebook®, WhatsApp®, or Instagram® of Menlo Park, Calif., Pinterest® of San Francisco, Calif., LinkedIn® of Mountain View, Calif., and others, without limitation or restriction.

In some examples, data may be formatted and transmitted (i.e., transferred over one or more data communication protocols) between computing resources using various types of data communication and transfer protocols such as Hypertext Transfer Protocol (“HTTP”), Transmission Control Protocol (“TCP”)/Internet Protocol (“IP”), Internet Relay Chat (“IRC”), SMS, text messaging, instant messaging (“IM”), File Transfer Protocol (“FTP”), or others, without limitation. As described herein, disclosed processes implemented as software may be programmed using Java®, JavaScript®, Scala, Python™, XML, HTML, and other data formats and programs, without limitation. Disclosed processes herein may also implement software such as Streaming SQL applications, browser applications (e.g., Firefox™) and/or web applications, among others. In some example, a browser application may implement a JavaScript framework, such as Ember.js, Meteor.js, ExtJS, AngularJS, and the like. References to various layers of an application architecture (e.g., application layer or data layer) may refer to a stacked layer application architecture such as the Open Systems Interconnect (“OSI”) model or others.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
generating a data model including engagement data objects, a subset of engagement data objects associated with an electronic account;
populating an engagement data object to include one or more of project data, billing data, and supply chain data;
analyzing a pool of data including the one or more of project data, billing data, and supply chain data to generate an engagement dataset including data representing attributes based on one or more aggregated subsets of project data, billing data, and supply chain data;
detecting a variation in a data value in the pool of data;
calculating updated values associated with the one or more aggregated subsets to update automatically the engagement dataset based on the variation in the data value; and
presenting in a user interface graphical data representing the one or more aggregated subsets of project data, billing data, and supply chain data.

2. The method of claim 1 further comprising:
causing generation of a command configured to modify automatically an enterprise process responsive to the variation in the data value; and
aggregating a first classification of data from the one or more of project data, billing data, and supply chain data to form a first aggregated dataset.

3. The method of claim 2 wherein the first aggregated dataset represents aggregated revenue data.

4. The method of claim 2 wherein aggregating the first classification of data comprises:
aggregating multiple streams of revenue data from each of the project data, billing data, and supply chain data.

5. The method of claim 4 wherein causing generation of the command configured to modify automatically the enterprise process comprises:
detecting the variation in the data value as a change in a financial unit of data associated with at least one of the multiple streams of revenue data.

6. The method of claim 1 wherein populating the engagement data object comprises:
activating an application to extract the one or more of project data, billing data, and supply chain data from multiple disparate data sources.

7. The method of claim 6 wherein activating the application comprises:
activating a runbook application configured to automatically access the multiple disparate data sources.

8. The method of claim 1 further comprising:
activating a project module to generate the project data;
activating a billing module to generate the billing data; and
activating a supply chain module to generate the supply chain data.

9. The method of claim 1 wherein presenting in the user interface the graphical data comprises:
generating data representing the user interface structured to include at least a first user interface portion configured to activate a first user input to identify one or more sources of revenue data originating at multiple disparate data sources and a second user interface portion configured to activate a second user input to identify an aggregated amount of revenue based on the one or more sources of revenue associated with the electronic account.

10. The method of claim 9 wherein generating the data representing the user interface comprises:
generating data representing a third user interface portion configured to implement a user input to activate implementation of the command to modify automatically the enterprise process.

11. A system comprising:
a data store configured to receive streams of one or more of project data, billing data, and supply chain data; and
a processor configured to execute instructions to implement an application configured to:
generate a data model including engagement data objects, a subset of engagement data objects associated with an electronic account;
populate an engagement data object to include one or more of project data, billing data, and supply chain data;
analyze a pool of data including the one or more of project data, billing data, and supply chain data to generate an engagement dataset including data representing attributes based on one or more aggregated subsets of project data, billing data, and supply chain data;
detect a variation in a data value in the pool of data;
calculate updated values associated with the one or more aggregated subsets to update automatically the engagement dataset based on the variation in the data value;
present in a user interface graphical data representing the one or more aggregated subsets of project data, billing data, and supply chain data; and
cause generation of a command configured to modify automatically an enterprise process responsive to the variation in the data value.

12. The system of claim 11 wherein the processor is further configured to:
aggregate a first classification of data from the one or more of project data, billing data, and supply chain data to form a first aggregated dataset.

13. The system of claim 12 wherein the first aggregated dataset represents aggregated revenue data.

14. The system of claim 12 wherein the processor configured to aggregate the first classification of data is further configured to:
aggregate multiple streams of revenue data from each of the project data, billing data, and supply chain data.

15. The system of claim 14 wherein the processor configured cause generation of the command configured to modify automatically the enterprise process is further configured to:
detect the variation in the data value as a change in a financial unit of data associated with at least one of the multiple streams of revenue data.

16. The system of claim 11 wherein the processor configured to populate the engagement data object is further configured to:
activate an application to extract the one or more of project data, billing data, and supply chain data from multiple disparate data sources.

17. The system of claim 16 wherein the processor configured to activate the application is further configured to:
activate a runbook application configured to automatically access the multiple disparate data sources.

18. The system of claim 11 wherein the processor is further configured to:
activate a project module to generate the project data;
activate a billing module to generate the billing data; and
activate a supply chain module to generate the supply chain data.

19. The system of claim 11 wherein the processor configured to present in the user interface the graphical data is further configured to:
generate data representing the user interface structured to include at least a first user interface portion configured to activate a first user input to identify one or more sources of revenue data originating at multiple disparate data sources and a second user interface portion configured to activate a second user input to identify an aggregated amount of revenue based on the one or more sources of revenue associated with the electronic account.

20. The system of claim 19 wherein the processor configured to generate the data representing the user interface is further configured to:
generate data representing a third user interface portion configured to implement a user input to activate implementation of the command to modify automatically the enterprise process.
